(19) United States
(12) Patent Application Publication
(10) Pub. No.: US 2020/0387519 A1
(43) Pub. Date: Dec. 10, 2020

(54) MACHINE GENERATED NAVIGATION GRAPH

(71) Applicant: Sony Interactive Entertainment LLC, San Mateo, CA (US)

(72) Inventors: Nicholas Robertson Hunter, San Francisco, CA (US); Jeffrey Thomas Hampton, San Ramon, CA (US); Ryan Neal Dy, San Francisco, CA (US)

(21) Appl. No.: 15/930,197

(22) Filed: May 12, 2020

Related U.S. Application Data
(60) Provisional application No. 62/847,198, filed on May 13, 2019.

(51) Int. Cl. G06F 16/25; G06F 16/901

(52) U.S. Cl. CPC G06F 16/258; G06F 16/9027; G06F 16/9024

(57) ABSTRACT

A navigation graph may be generated by performing an Abstract Syntax Tree (AST) Conversion on machine-readable or machine-generated source information to generate a navigation graph in AST format with mappings back to original Data Labeling Sources for the source information. The Navigation Graph in AST format includes nodes connected by unidirectional arcs. Each arc is labeled by a cost of traversal and a probability of traversal. Outside entry points to the Navigation Graph in AST format and optimal paths through the Navigation Graph are identified by applying a Directed Graph Filtering Algorithm thereby producing an Optimized Navigation Graph in which the probability of traversal for one or more of the unidirectional arcs is based in part on user behavior information.

### CLAIM OF PRIORITY

This application claims the priority benefit of U.S. Provisional Patent Application No. 62/847,198, filed May 13, 2020.

### FIELD OF THE DISCLOSURE

Aspects of the present disclosure are related to data structures and more specifically to generating and using navigation graphs.

### BACKGROUND OF THE INVENTION

Modern computer systems utilize multiple applications that are related to each other through some managing program. For example, in the case of a suite of related applications, e.g., Microsoft Office, the managing program for the suite applications is known as a suite manager. In other cases, managing program may be a common operating system. In order for managing program to update data for different applications it must understand the data needed by each application. To understand the data, the managing program must internalize the code for each application. Given the proliferation of and complexity of applications it is often labor intensive and highly dynamic to identify the optimum path to fetch data quickly within an application and to identify the source and classification of data, e.g., with respect to privacy parameters.

Thus, it is a non-trivial problem for a managing program to dynamically acquire necessary data when switching from one application to another or when transitioning from an entry point (i.e., no application) to an application.

It is within this context that aspects of the present disclosure arise.

### SUMMARY

According to aspects of the present disclosure, a Navigation Graph can be generated from machine-readable or machine-generated sources that can be represented by an Abstract Syntax Tree (see Abstract Syntax Tree). An Abstract Syntax Tree (AST) Conversion (A) takes the source information and generates an AST format with mappings back to the original Data Labeling Sources (B). The Navigation Graph can then be passed to a Directed Graph Filtering Algorithm to identify outside entry points (Source Vertices (D)) and optimal paths through the graph (Pathfinding Processing (D)). The resulting, Optimized AST can then be converted back into various formats, including a reverse transformation into Generated Source Code.

### BRIEF DESCRIPTION OF THE DRAWINGS

The teachings of the present disclosure can be readily understood by considering the following detailed description in conjunction with the accompanying drawings, in which:

FIG. 1 is a block diagram illustrating an example of a navigation graph according to an aspect of the present disclosure.

FIG. 2 is a flow diagram illustrating an example of a method for generation of navigation graph according to an aspect of the present disclosure.

FIG. 3 is a block diagram illustrating an example of a navigation graph optimized for network latency according to an aspect of the present disclosure.

FIG. 4 is a block diagram illustrating an example of a system for generation of navigation graph according to an aspect of the present disclosure.

### DETAILED DESCRIPTION

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

In the interest of clarity, not all of the routine features of the implementations described herein are shown and described. It will be understood by those skilled in the art that in the development of any such implementations, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of the present disclosure.

In accordance with aspects of the present disclosure, the components, process steps, and/or data structures may be implemented using various types of operating systems; computing platforms; user interfaces/displays, including personal or laptop computers, video game consoles, PDAs and other handheld devices, such as cellular telephones, tablet computers, portable gaming devices; and/or general purpose machines. In addition, those of ordinary skill in the art will recognize that devices of a less general purpose nature, such as hardwired devices, field programmable gate arrays (FOGs), application specific integrated circuits (ASICs), or the like, may also be used without departing from the scope and spirit of the inventive concepts disclosed herein.

### Introduction

### Generation of Navigation Graph

A Navigation Graph generated as described herein would provide a managing program, e.g., a suite manager, operating system, or browser, with a unified representation of the requirements of the applications it manages. This enables the managing program to understand and update data for different related applications independent of a managing program without having to internalize all the code for all of the applications. To optimize for latency, the Navigation graph can be configured to pre-fetch needed data based on probabilities, which may be determined from information about the user. Such information may include information about the specific user's past behavior or demographic information about the user. Such a Navigation Graph could be implemented, e.g., at the level of a suite manager for a suite, as a daemon for an operating system, or as a background process for a browser.

To do this, the manager program needs to build a Data Schema Definition and a Navigation Schema Definition. The Data Schema Definition describes the data used in an application in terms of what the data element is and how it is obtained. Rather than describing the application data as columns and rows in a spreadsheet, the Data Schema Definition describes the data as a shared understanding of what (or who) the user is and how the information is obtained. By way of example, and not by way of limitation, the user could be a customer (identified, e.g., by a customer number), having accounts (identified, e.g., by corresponding account numbers) in a bank, that has branches (identified by branch ID). The information may be obtained by a query, e.g., a retrieval of information associated with the user or a mutation, e.g., some form of modification of the information associated with the user.

Referring to the bank customer example, a query may be in the form of an executable operation, such as “GetUserWithAccounts” (customer #). Again, in the context of the bank customer example, one type of mutation could be a deposit into an account in the form of an executable operation specifying, e.g., the account number and the amount to be deposited.

The Navigation Schema Definition is a hierarchical representation of features of the data used within an application. The Navigation Schema Definition specifies what data is used at particular locations (e.g., pages or screens) within the application. By way of example, and not by way of limitation, in a social media application, such as Facebook, the features may include a navigation bar, news feed, navigation options, advertisements, posting (text, photo, video, comment). The hierarchical representation at some level is consistent across platforms, e.g., computer, phone, tablet, etc.

Although such data schema and navigation schema definitions have been done, they are currently generated manually, which is costly and time consuming. To overcome these drawbacks, aspects of the present disclosure include a method for automatically generating a navigation graph. To do this an Abstract Syntax Tree (AST) Conversion is performed on machine-readable or machine-generated source information to generate a navigation graph in AST format with mappings back to original Data Labeling Sources for the machine-readable or machine-generated source information. The Navigation Graph in AST format includes a set of nodes connected by unidirectional arcs. Each arc is labeled by a cost of traversal and a probability of traversal. Outside entry points to the Navigation Graph in AST format and optimal paths through the Navigation Graph in AST format are then identified by applying a Directed Graph Filtering Algorithm to the Navigation Graph in AST format thereby producing an Optimized Navigation Graph in which the probability of traversal for one or more of the unidirectional arcs that is based in part on user behavior information. The Optimized Navigation Graph may then be converted into Generated Source Code that can be used by a managing program.

### Unified Syntax Mapping

The Abstract Syntax Tree conversion puts the source information in a format intermediary between human written code and binary code. As is generally understood by those skilled in the computer arts, an abstract syntax tree (AST), or just syntax tree, is a tree representation of the abstract syntactic structure of source code written in a programming language. Each node of the tree denotes a construct occurring in the source code. The syntax is said to be “abstract” in the sense that it does not represent every detail appearing in the real syntax, but rather just the structural, content-related details. For instance, grouping parentheses are implicit in the tree structure, and a syntactic construct like an if-condition-then expression may be denoted by means of a single node with three branches. In an AST conversion, code written by a programmer is parsed into an AST, which is then converted to bytecode that can be run on a virtual machine. For example, the source code “let x=2” would be parsed into AST as instructions declaring the variable “x”, specifying the operation, e.g., assignment of the value to the variable x.

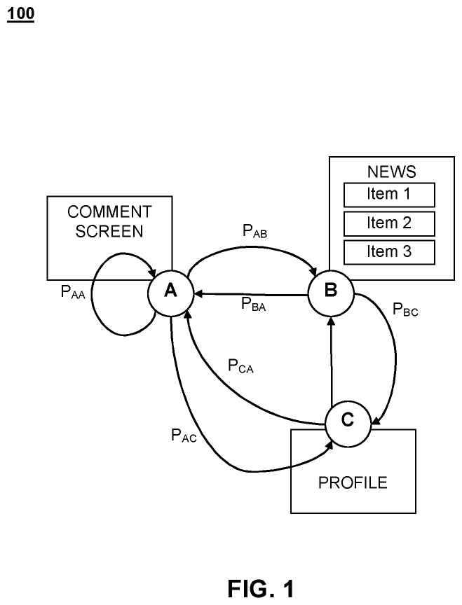

According to aspects of the present disclosure, the resulting AST is interpreted as a directional graph, i.e., a set of nodes connected by unidirectional arcs. FIG. 1 depicts an example of such a directional graph 100 having nodes A, B, and C that are connected by arcs. Each node can be thought of as points of user interaction within the context of an application or set of related applications. In the illustrated example node A is a comment screen for the application, node B is a news feed for the application, and node C is user profile screen. The nodes can be cyclic and/or self-referencing. Node A is said to be cyclic since one arc connect A to B but a different arc would connect B back to A. Node A could also be self-referencing if an arc connects node A back to itself.

Once the AST has been generated, a generating program is executed to automatically label the nodes and the arcs. Result of Labeling Nodes and Arcs is a weighted network. Each node is labeled with a Data Schema Item and a Navigational Schema Item. For example, if a node in a social media application corresponds to a News feed item, a post, a comment button, or a comment screen; the location can be mapped back to the Data Schema Definition.

According to aspects of the present disclosure arc labels generally include two pieces of information: a Network Access Cost (e.g., in terms of time to traverse the arc) and Probability of Access (on a scale of say, 0-1). In FIG. 1, the arc connecting node A to node B is labeled with the probability P_{AB} and the node connecting node B back to node A is labeled with the probability P_{BA}. The arc connecting node A back to itself is labeled with the probability P_{AA}. For a given node, the sum of all probabilities of traversing an exit arc must add up to 1. These probabilities can be based partly on past user behavior and can be updated dynamically each time a specific user accesses a given node. These probabilities can be based partly on behavior of the user's demographic. If there is no user behavior history or demographic history initial values can be arbitrarily assigned and updated as historical information becomes available. For example, if there are only two exit arcs from a node each could initially have a 50% probability of traversal.

To understand the utility of the weighted network depicted in FIG. 1, suppose that the user is at comment screen (node A) and wants to look at B (the newsfeed screen). Suppose the probability P_{AB} of going from node A to node B is 0.95 but the cost of traversing A to B is 100. Suppose the probability of going from node A to node C (Profile) is 0.01 but the cost of traversing A to C is 50. It is desirable to reduce the cost for a known probability. A naïve solution for doing so is to follow the path having least cost. However, there is a difficulty in optimizing cost of high probability arcs. If the cost is sufficiently low no action is needed to reduce the cost. However, if the cost of traversing a high-probability arc is relatively high the cost can be reduced by pre-fetching the data. Pre-fetching, as used herein, refers to obtaining data for a target node prior to a user initiating traversal of an arc to the target node. Pre-fetching is most desirable for costs with both a high probability and high cost of traversal. In this example, if a user starting at node A he is likely to next go to node B based on the user's past history. The system can be configured to pre-fetch the necessary data for node B and/or initiate access to node B before the user initiates the access to node B thereby decreasing the cost of accessing node B.

### Generation of Navigation Graph

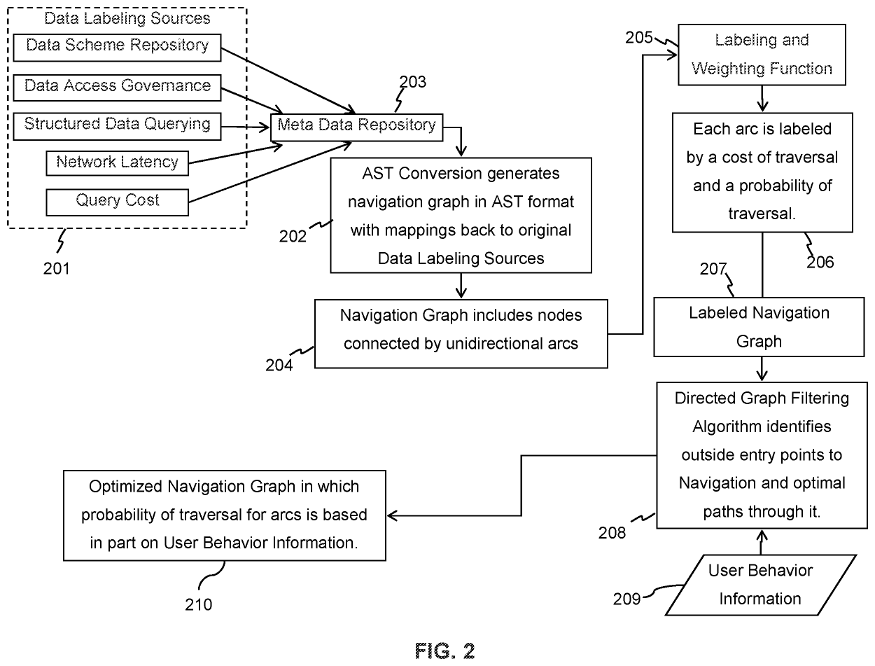

FIG. 2 depicts an example of automatic generation of a navigation graph in accordance with aspects of the present disclosure. The navigation graph is generated from machine-readable or machine-generated source information related to an application or set of related applications. The source information may be obtained from various sources 201 associated with the application(s). Examples of such sources include, but are not limited to a data schema repository, data access governance, structured data querying, network latency data, and query cost data. The source information may be collected by a system or process that is separate from the navigation graph generation system and stored in a metadata repository 203 that can be accessed remotely by the navigation graph generating system. Once the data has been collected the navigation graph generating system performs an Abstract Syntax Tree (AST) Conversion on the source information, as indicated at 202, to generate a navigation graph 202 in AST format with mappings back to original Data Labeling Sources 201 for the source information. The Navigation Graph in AST format includes a set of nodes connected by unidirectional arcs, wherein each unidirectional arc is labeled by a cost of traversal and a probability of traversal, as discussed above. The arcs may be labeled by a labeling and weighting function 205 that labels each arc with the cost and probability of traversal, as indicated at 206 thereby producing a labeled Navigation Graph 207.

A Directed Graph Filtering Algorithm is then applied to the Labeled Navigation Graph identifying outside entry points to the Navigation Graph in AST format and optimal paths through the Navigation Graph, as indicated at 208 to produce an Optimized Navigation Graph 210 in which the probability of traversal for one or more of the unidirectional arcs that is based in part on user behavior information 209.

The Navigation Graph may be optimized for latency by prefetching data according to the user behavior data 209. The Navigation Graph is configured to pre-fetch needed data for a target node of the set of nodes based on a probability of traversing an exit arc from a given node to the target node. The Optimized Navigation Graph may be implemented at the level of a managing program, e.g., a suite manager configured to manage two or more related applications, a daemon for an operating system, or a background process for a browser.

### Optimization of Weighted Network

Any of a number of Weighted Network Optimization algorithms may be used to optimize the weighted network. By way of example, and not by way of limitation, Closeness and/or Betweenness of nodes can be optimized, e.g., using Dijkstra's distance algorithm. As used herein, and as is generally understood to the skilled in the art of weighted networks, closeness of a node is calculated as the reciprocal of the sum of the length of the shortest paths between the node and all other nodes in the graph. In graph theory, betweenness centrality (referred to herein as betweenness) is a measure of centrality in a graph based on shortest paths. For every pair of nodes in a connected graph, there exists at least one shortest path between the nodes such that the sum of the weights of the edges (for weighted graphs) is minimized. The betweenness for each node is the number of these shortest paths that pass through the node.

Dijkstra's algorithm assigns some initial distance values and tries to improve them step by step in the following manner. The following describes use of Dijkstra's distance algorithm to determine a path from an initial node to a destination node.
1. All nodes are initially marked “unvisited” to create a set of all the unvisited nodes called the unvisited set.
2. Every node is then assigned a tentative distance value: zero for the initial node and to infinity for all other nodes. The initial node is set as the current node.
3. Calculate the tentative distance to all of the current node's unvisited neighbors through the current node. Compare the newly calculated tentative distance to the current assigned value and assign the smaller one.
4. After considering all of the unvisited neighbors of the current node, the current node is marked as “visited” and removed from the unvisited set. A visited node will never be checked again.
5. If the destination node has been marked visited, then stop. The algorithm has finished.
6. Otherwise, select the unvisited node that is marked with the smallest tentative distance, set it as the new “current node”, and go back to step 3.

In some implementations, the weighted network may be optimized by redefining a global or local. As is generally understood by those skilled in the art of connected graphs the global Clustering Coefficient is based on triplets of nodes. A triplet is three nodes that are connected by either two (open triplet) or three (closed triplet) undirected ties. The global Clustering Coefficient is the number of closed triplets divided by the number of all open and closed triplets. According to aspects of the present disclosure, the global Clustering Coefficient can be redefined using a triplet value.

The local clustering coefficient for a node is given by the proportion of links between the other nodes within its neighborhood (i.e., those nodes to which it is directly connected) divided by the number of links that could possibly exist between the other nodes. According to aspects of the present disclosure, the local Clustering Coefficient can be redefined using a triplet value or an algebraic formula.

### Distributed Definition and Consumption of Weighted Networks

According to aspects of the present disclosure Weighted Networks may be automatically generated for Combinations. As used herein, a Combination would be Suite of related applications (or two or more such Suites) in conjunction with a weighted network. A suite combined with a weighted network can take the user to different places without the suite having specific knowledge of its child applications. Suites can hoist the network definition to wherever the entry point to a child application (or child network) is within a parent network.

In accordance with aspects of the present disclosure, the probabilities for exit arcs from a given node (or network of nodes) must be re-normalized when the user accesses the node or network. This may change the order in which data needs to be fetched.

Application—Automated Determination of What Data to Fetch without Further User Action Once the User Initiates Access to a Suite or Operating System Using the Weighted Network.

In some implementations, certain considerations may affect which data is pre-fetched or whether it can be fetched at all. For example, there may be privacy issues limiting access to certain data, e.g., health care data. Alternatively, the user may have restricted access to certain data under certain legal regimes, such as the European Union's General Data Protection Regulation (GDPR). In such implementations the nodes within the data schema definition can classify data with privacy metadata. This allows a suite or application to determine whether or not to send the data to comply with GDPR. In other implementations a weighted network generated according to aspects of the present disclosure could show the user where their data is being used for government and privacy purposes.

### Application—Bundle Splitting

According to aspects of the present disclosure, a automatically generated navigation graph can be used for unbundling of code files. For example, each Java Script is an individual file. A common optimization is to bundle individual files into a common file. In such cases, it is necessary to download an entire application file and parse it before anything can be done with the code. Unbundling involves identifying the needed parts of the code from the common file and executing them. According to aspects of the present disclosure the unbundling could be automated by using an automatically generated navigation graph that identifies the code portions that are needed and the order in which they need to run in terms of their probability and cost. For example, the navigation graph for an application could have nodes representing each utility within the application connected by arcs weighted according a user's past history of use of the utilities within the application. The probabilities associated with the arcs could be optimized for the utilities that a user accesses most often.

### Application—Optimizing to Reduce Network Latency

According to aspects of the present disclosure, a weighted network generated, as discussed above could be used in applications through which a user can access multiple utilities over a network. In such cases, the user's device is often used to access a suite of applications and utilities that are housed on one or more remote servers. Access to such applications and utilities may be affected by network latency, i.e., the round trip time between the user's device and the remote server. A managing program handles the user's interactions with related applications accessed over the network. A navigation graph generated as discussed above could provide the managing program with a unified representation of the requirements of the applications it manages. The network latency is part of the cost of accessing a given application. To optimize for latency, the Navigation graph can be configured to pre-fetch needed data based on probabilities, which may be determined from a history of user behavior.

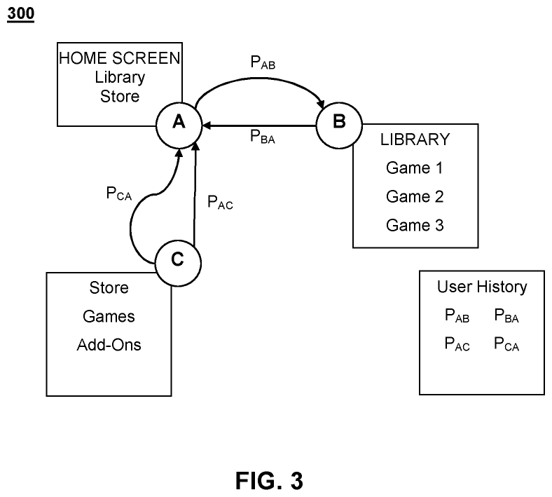

FIG. 3 illustrates an example of a Navigation Graph 300 for a managing program that manages a cloud gaming system for which the user has an account. The gaming system includes a large number of games and includes a store for purchasing games and add-ons for those games (node C). The user has access to games associated with their account through a game library (node B). The user can access the store and the library through a home screen (node A) but, for the sake of simplicity, cannot access the store from the library or vice versa. The graph-generating system keeps track of each user's behavior as they access the account and updates the exit probabilities P_{AB}, P_{BA}, P_{AC}, P_{CA} for the nodes accordingly. For example, suppose User 1 consistently goes to store page after opening the home screen. The game system (or the graph-generating program) would correspondingly increase the probability P_{AB} of going from the home screen to the store and decrease the probability P_{AC} of going from the home screen to the library for User 1. From these probabilities the gaming system determines that it needs to load the home screen and then load the store the next time User 1 accesses the system. Suppose User 2 consistently opens system and then goes to game library and uses a particular game (Game 1) of a few different games in the library. The game system (or the graph-generating program) would correspondingly increase the probability P_{AC} of going from the home screen to the store and decrease the probability P_{AB} of going from the home screen to the store for User 2. From these probabilities the gaming system can determine that it needs to load the home screen and then load Game 1.

There are many variations on the examples discussed above. For example, the Navigation Graph 300 may be configured so that the data for the highest value items from store are loaded first to maximize revenue. For implementations involving on-line advertising, the Navigation Graph 300 could selectively pre-fetch advertisements to maximize the time spent on an ad page.

### Navigation Graph System

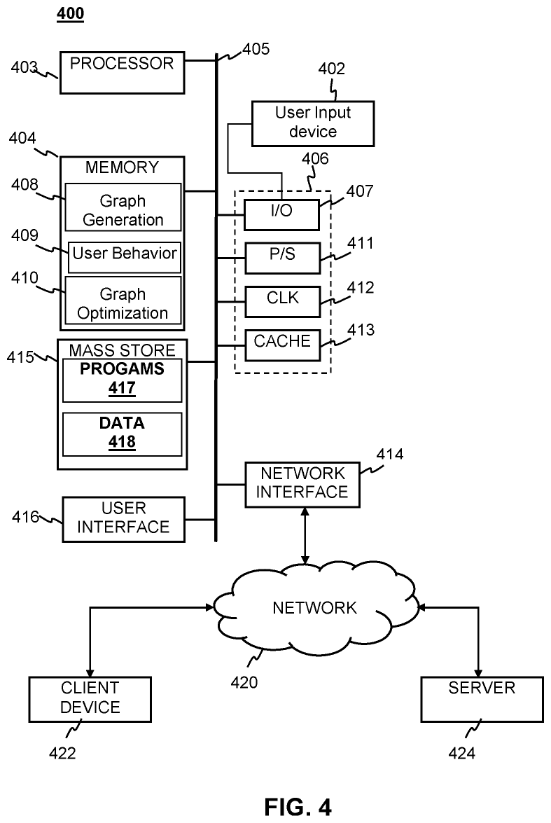

FIG. 4 depicts a Navigation Graph generation and optimization system 400 according to aspects of the present disclosure. The system 400 may include a user input device 402, a controller, touch screen, microphone, keyboard, mouse, joystick or other device that allows a user to input information including sound data in to the system.

The system 400 may include one or more processor units 403, which may be configured according to well-known architectures, such as, e.g., single-core, dual-core, quad-core, multi-core, processor-coprocessor, cell processor, and the like. The computing device may also include one or more memory units 404 (e.g., random access memory (RAM), dynamic random access memory (DRAM), read-only memory (ROM), and the like).

The processor unit 403 may execute one or more programs, portions of which may be stored in the memory 404 and the processor 403 may be operatively coupled to the memory, e.g., by accessing the memory via a data bus 405. The programs may include a Navigation Graph generation program 408 and a Navigation Graph optimization program 410, which may implement the method described above with respect to FIG. 2. Additionally the Memory 404 may contain user behavior information 409, which may be used by the Navigation Graph generation program 408 and Navigation Graph optimization program 410, as discussed above. The aforementioned programs and user information may also be stored as data 418 in a Mass Store 418, such as a disk drive, CD-ROM drive, tape drive, flash memory, or the like.

The system 400 may also include well-known support circuits, such as input/output (I/O) components 407, power supplies (P/S) 411, a clock (CLK) 412, and cache 413, which may communicate with other components of the system, e.g., via the bus 405. The computing device may include a network interface 414 to facilitate communication via an electronic communications network 420, e.g., a local area network (LAN) or personal area network (PAN), via a suitable network protocol, e.g., Bluetooth, for a PAN. The system 400 may also include a user interface 416 to facilitate interaction between the system and a user. The user interface may include a monitor, Television screen, speakers, headphones or other devices that communicate information to the user.

The network interface 414 may be configured to implement wired or wireless communication over local area networks and wide area networks such as the Internet. This allows the system 400 to access remote devices, such as client devices or servers, and vice versa. The device 400 may send and receive data and/or requests for files via one or more message packets over the network 420. Message packets sent over the network 420 may temporarily be stored in a buffer 409 in memory 404.

Aspects of the present disclosure provide an automated way for a managing program to understand the data needed by different application without having to internalize the code for each application it manages. This vastly simplifies the often labor intensive and highly dynamic process of identifying optimum paths to fetch data quickly within an application and to identify the source and classification of data.

While the above is a complete description of the preferred embodiments of the present invention, it is possible to use various alternatives, modifications, and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for”. Any element in a claim that does not explicitly state “means for” performing a specified function, is not to be interpreted as a “means” or “step” clause as specified in 35 USC § 112, ¶6.

What is claimed is:

1. A method for generating a navigation graph, comprising:
performing an Abstract Syntax Tree (AST) Conversion on machine-readable or machine-generated source information to generate a navigation graph in AST format with mappings back to original Data Labeling Sources for the machine-readable or machine-generated source information, wherein the Navigation Graph in AST format includes a set of nodes connected by unidirectional arcs, wherein each unidirectional arc is labeled by a cost of traversal and a probability of traversal;
identifying outside entry points to the Navigation Graph in AST format and optimal paths through the Navigation Graph in AST format by applying a Directed Graph Filtering Algorithm to the Navigation Graph in AST format thereby producing an Optimized Navigation Graph in which the probability of traversal for one or more of the unidirectional arcs that is based in part on user behavior information.

2. The method of claim 1, wherein the cost of traversal corresponds to a time to traverse the arc.

3. The method of claim 1, wherein the user behavior information includes information about behavior of a user's demographic.

4. The method of claim 1, wherein the user behavior information includes information about past behavior of a specific user.

5. The method of claim 1, further comprising updating probability for each of one or more exit arcs for a given node in the Optimized Navigation Graph each time a user accesses the given node.

6. The method of claim 1, further comprising converting the Optimized Navigation Graph into Generated Source Code.

7. The method of claim 1, further comprising implementing the Optimized Navigation Graph at the level of a managing program configured to manage two or more related applications.

8. The method of claim 7, wherein the managing program is a suite manager for a suite of two or more related programs.

9. The method of claim 7, wherein the managing program is a daemon for an operating system.

10. The method of claim 7, wherein the managing program is a background process for a browser.

11. A Navigation Graph generation system, comprising:
a processor;
memory coupled to the processor;
non-transitory instructions embedded in the memory that when executed cause the processor to implement a method for generating a navigation graph, the method comprising:
performing an Abstract Syntax Tree (AST) Conversion on machine-readable or machine-generated source information to generate a navigation graph in AST format with mappings back to original Data Labeling Sources for the machine-readable or machine-generated source information, wherein the Navigation Graph in AST format includes a set of nodes connected by unidirectional arcs, wherein each unidirectional arc is labeled by a cost of traversal and a probability of traversal;
identifying outside entry points to the Navigation Graph in AST format and optimal paths through the Navigation Graph in AST format by applying a Directed Graph Filtering Algorithm to the Navigation Graph in AST format thereby producing an Optimized Navigation Graph in which the probability of traversal for one or more of the unidirectional arcs that is based in part on user behavior information.

12. Non-transitory instructions embedded in a computer readable medium that when executed cause a computer to implement a method for generating a navigation graph, the method comprising:
performing an Abstract Syntax Tree (AST) Conversion on machine-readable or machine-generated source information to generate a navigation graph in AST format with mappings back to original Data Labeling Sources for the machine-readable or machine-generated source information, wherein the Navigation Graph in AST format includes a set of nodes connected by unidirectional arcs, wherein each unidirectional arc is labeled by a cost of traversal and a probability of traversal;
identifying outside entry points to the Navigation Graph in AST format and optimal paths through the Navigation Graph in AST format by applying a Directed Graph Filtering Algorithm to the Navigation Graph in AST format thereby producing an Optimized Navigation Graph in which the probability of traversal for one or more of the unidirectional arcs that is based in part on user behavior information.

13. A method, comprising:
optimizing a Navigation Graph for latency by prefetching data, wherein the Navigation Graph includes a set of nodes connected by unidirectional arcs, wherein each unidirectional arc is labeled by a cost of traversal and a probability of traversal that is based in part on user behavior information, wherein the Navigation Graph pre-fetches needed data for a target node of the set of nodes based on a probability of traversing an exit arc from a given node to the target node.

14. The method of claim 13, wherein the Optimized Navigation Graph is implemented at the level of a managing program configured to manage two or more related applications.

15. The method of claim 14, wherein the managing program is a suite manager for a suite of two or more related programs.

16. The method of claim 14, wherein the managing program is a daemon for an operating system.

17. The method of claim 14, wherein the managing program is a background process for a browser.

18. A system, comprising:
a processor;
memory coupled to the processor;
non-transitory instructions embedded in the memory that when executed cause the processor to implement a method, the method comprising:
optimizing a Navigation Graph for latency by prefetching data, wherein the Navigation Graph includes a set of nodes connected by unidirectional arcs, wherein each unidirectional arc is labeled by a cost of traversal and a probability of traversal that is based in part on user behavior information, wherein the Navigation Graph pre-fetches needed data for a target node of the set of nodes based on a probability of traversing an exit arc from a given node to the target node.

19. Non-transitory instructions embedded in a computer readable medium that when executed cause a computer to implement a method, the method comprising:
optimizing a Navigation Graph for latency by prefetching data, wherein the Navigation Graph includes a set of nodes connected by unidirectional arcs, wherein each unidirectional arc is labeled by a cost of traversal and a probability of traversal that is based in part on user behavior information, wherein the Navigation Graph pre-fetches needed data for a target node of the set of nodes based on a probability of traversing an exit arc from a given node to the target node.
